(19) United States
(12) Patent Application Publication
(10) Pub. No.: US 2005/0079040 A1
(43) Pub. Date: Apr. 14, 2005

(54) Lift system, lift retrofit system and method for installation of same

(76) Inventor: Roger Perlstein, Niskayuna, NY (US)

Correspondence Address: Schmeiser, Olsen & Watts LLP, Suite 201, 3 Lear Jet Lane, Latham, NY, 12110, US

(21) Appl. No.: 10/961,924

(22) Filed: Oct. 8, 2004

Related U.S. Application Data
(60) Provisional application No. 60/510,018, filed on Oct. 9, 2003.

(51) Int. Cl. B60P 3/00

(52) U.S. Cl. 414/540

(57) ABSTRACT

A lift system, lift retrofit system and method for installation of same is disclosed. The device includes a casing and a vehicle lift mechanism configured to fit within the casing. The lift mechanism includes a load receiving element which is configured to receive substantially all of a load from the vehicle lift mechanism. The device or the retrofit is configured to overcome the problem of “punching” load, or “point” load created at the center of the lift.

### RELATED APPLICATIONS

The present invention claims priority to U.S. Provisional Application No. 60/510,018, filed Oct. 9, 2003, which is incorporated herein by reference in its entirety.

### BACKGROUND OF INVENTION

1. Technical Field

This invention relates generally to the field of hydraulic vehicle lift systems. More particularly, this invention provides for an improved lift system as well as an improved retrofit system and methods of installing the same.

2. Related Art

In a typical retrofit system where a Low Volume, High Pressure hydraulic piston (i.e., lifting means) is installed in the casing, the width of the lower portion of the piston is smaller in width than the bottom of the casing. In many cases, the piston is significantly smaller in width than the bottom of the casing. As a result, in many retrofit systems a “punching” load, or “point” load is created at the center of the bottom. This is undesirable because, frequently, the integrity of the casing bottom is unknown, or degraded. This can result in the puncturing of the bottom of the casing which further results in the leakage of hydraulic fluid into adjacent substrate (e.g., soil) and/or catastrophic collapse of the lift's superstructure.

Thus, there is a need for improvement in the art of vehicle lifts that overcome at least one of the aforementioned deficiencies, and possibly others. The present invention is an improvement on lift retrofit systems of existing, used vehicle lifts and a method to install the same. The present invention also offers similar improvements for installing new lift systems.

### SUMMARY OF INVENTION

The present invention provides various devices that create an improved vehicle lift system, both new and retrofit systems, and methods of installing the same.

A first general aspect of the invention provides a bearing device for retrofitting a vehicle lift system, wherein said vehicle lift system includes a casing with an opening at proximal end of an upper portion and a bottom at a distal end, said device comprising:

a first end adapted to receive a vehicle lifting device; and

a second end adapted to operatively attach to said upper portion.

A second aspect includes a device for retrofitting a vehicle lift system, wherein said vehicle lift system includes a casing, said casing having an upper portion and a bottom portion, said casing inserted within a floor having an opening therein and a bottom at the distal end of the casing, said device comprising:

a first end adapted to receive a vehicle lifting device; and

a second end adapted to operatively attach at least one of said floor and said upper portion.

A third general aspect of the present invention includes a load transference device for use with vehicle lift systems, said systems including a casing and a vehicle lift mechanism configured to fit within said casing, said device comprising:

a load receiving element, said element configured to receive substantially all of a load from said vehicle lift mechanism;

at least one load transferring element, structurally attached to said load receiving element, configured to receive all of said load;

at least one attachment flange, structurally attached to said at least one load transferring element, configured to attach to at least one of an upper portion of said casing and a slab adjacent to said casing, configured to receive all of said load; and

further wherein, said device is configured to substantially fit within said casing.

A fourth general aspect of the present invention includes a device for use with a vehicle lift system, said system including a casing for receiving a pneumatic vehicle lifting device, said lifting device including a ram and a cylinder operatively attached to a superstructure, said device comprising:

a cylindrical element, configured to be attached between said lifting device and said superstructure, said element including on an outside surface a plurality of engagement locations, said plurality of locations configured to be operatively engagable with a safety mechanism.

A fifth general aspect of the present invention includes a method of retrofit of a pre-existing vehicle lift system, the method comprising the steps of:

removing a plunger of the pre-existing vehicle lift system;

installing a self contained or sealed hydraulic cylinder and associated hydraulic lines within a casing of the pre-existing vehicle lift system; and

installing a plunger associated with said cylinder using said casing or a sleeve therein as a guide for said plunger.

The foregoing and other features of the invention will be apparent from the following more particular description of various embodiments of the invention.

### BRIEF DESCRIPTION OF THE DRAWINGS

Some of the embodiments of this invention will be described in detail, with reference to the following figures, wherein like designations denote like members, wherein:

FIG. 1A depicts an elevation sectional view of a portion of a vehicle lift system from the related art;

FIG. 1B depicts an elevation sectional view of a portion of a movable vehicle lift system from the related art;

FIG. 2A depicts a perspective view of a first embodiment of a bearing insert device and height adjustment mechanism, in accordance with the present invention;

FIG. 2B depicts a perspective view of a second embodiment of a bearing insert device, in accordance with the present invention;

FIG. 2C depicts a perspective view of a third embodiment of a bearing insert device, in accordance with the present invention;

FIG. 3 depicts a elevation sectional view of an embodiment of a lift system employing an device similar to the embodiment in FIG. 2A, in accordance with the present invention; and

FIG. 4 depicts an exploded perspective view of the embodiment of the lift system in FIG. 3, in accordance with the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

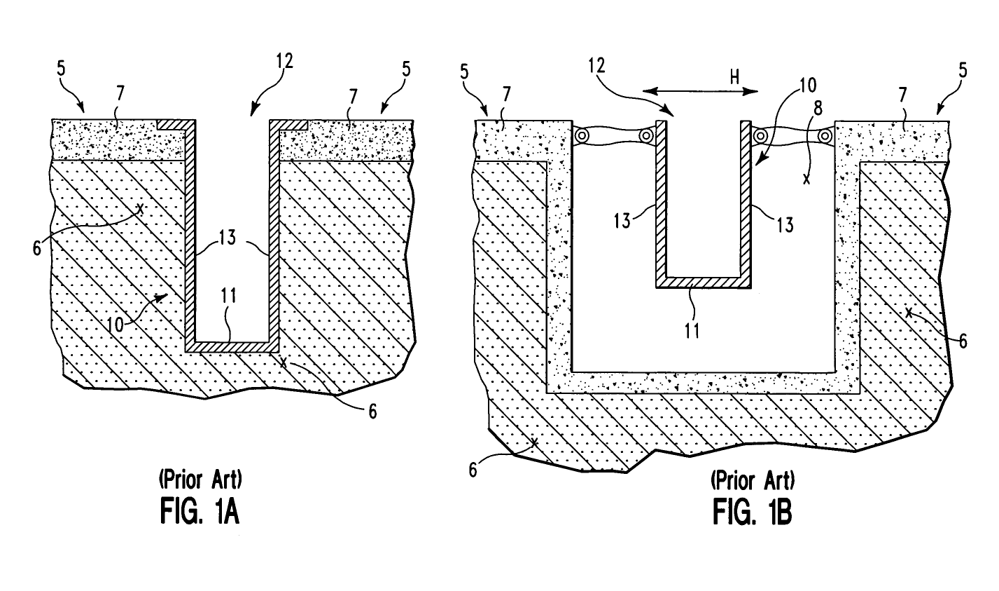

Referring to the drawings, FIG. 1A and 1B, both depict embodiments of portions of vehicle lift systems. As FIGS. 1A and 1B depict portions of a typical lift system includes a top opening 12 from which extends downward a pre-existing casing 10. The casing 10 includes a wall 13. The casing 10 typically is round in cross-section. At the distal end of the pre-existing casing 10 is the bottom 11 of the casing 10. The embodiment in FIG. 1B is a movable vehicle lift system wherein the casing 10 is in mechanical communication with a translation system that creates and allows horizontal movement (depicted by directional arrow “H”) of the casing 10. This allows the vehicle lift to be horizontally adjustable so as to adapt to various wheelbase lengths. The casing 10 and translation system are typically suspended over a pit 8 that is formed from concrete. Although shown the system are depicted in two separate figures (i.e., FIGS. 1A and 1B), it should be apparent that both embodiments in the figures can, in fact, be used together at a vehicle lift area. For example, the “fixed” system of FIG. 1A may be used to lift under the rear wheel of a vehicle, while the “movable” system of FIG. 1B may be adjusted properly to lift under the front wheel of the same vehicle (e.g., bus, truck, car, etc.).

This invention offers an improvement over existing vehicle lifts. Also, it should be noted that although, the following disclosure discusses an application that is for retrofitting an existing High Volume, Low Pressure, hydraulic lift or an existing Low Volume, High Pressure hydraulic lift, the invention can be used in many more applications. For example, the features of the invention can be used in an entirely new vehicle lift installation (i.e., not a retrofit). Also, the new lifting means 15 to be installed need not only be a Low Volume, High Pressure hydraulic lift. The new lifting means 15 may alternatively be a new High Volume, Low Pressure hydraulic lift, an electromechanical screw lift, a ball screw-type lift, a pneumatic (e.g., air) lift, or hydraulic lifts of any suitable pressures and volumes. Similarly, if the lifting means 15 is replaced under the present invention, the “old” lifting means 15 can be of any of the aforementioned systems. The present invention (which has several aspects to it) can be used, not only with a brand-new installation, or with a retrofitting of a lift system, but also when providing improvements to a already retrofitted lift system (i.e., a retrofitting of a previously retrofitted lift system).

Whether it is a new lift system or a retrofit system, this portion of the invention relates to where the various loads of the lift system (new, existing, or retrofit system) are distributed. An aspect of this invention is a lift bearing, bearing “insert”, or first bearing element 20, which changes entirely, or in part, where the various loads of the lift ultimately bear.

This embodiment instead distributes part, or all, of the system load(s) ultimately to locations other than the center portion of the bottom 11 of the casing. This redistribution of the load offers several advantages, including avoiding said puncturing of the bottom 11 of the pre-existing casing 10, ease of maintenance, improved strength, increased capacity, etc.

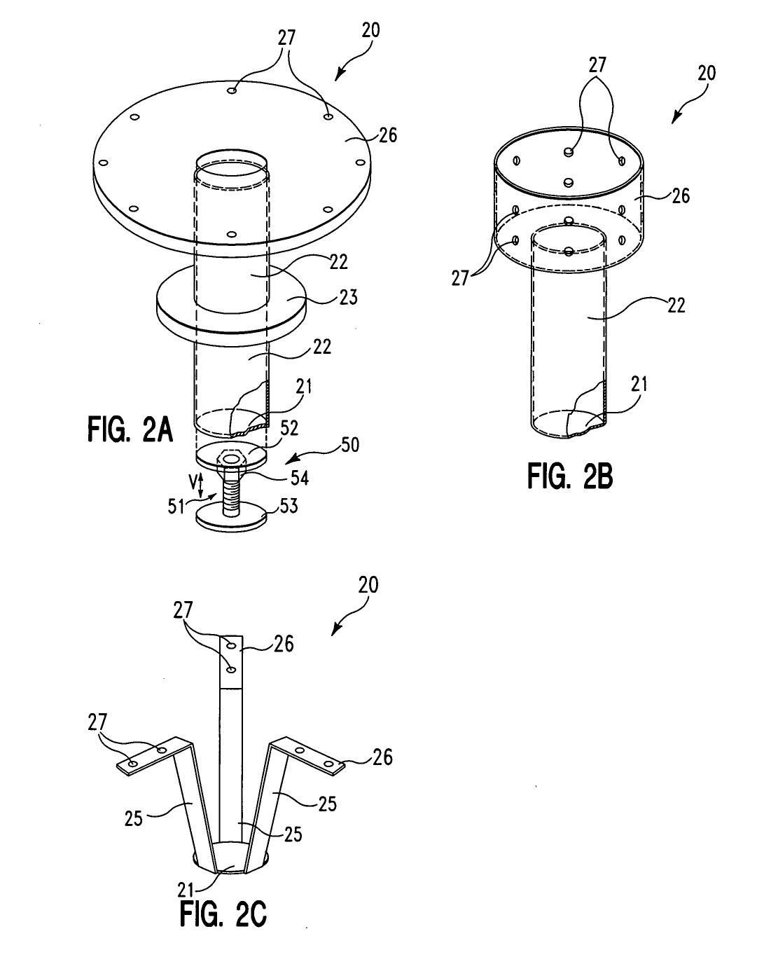

This embodiment includes operatively attaching a new lifting mechanism 15 (e.g., HPLV hydraulic piston/ram) to other various locations besides just to the bottom 11 of the pre-existing casing. This redistribution of the load of the lifting mechanism 15 can be used in an entirely new lift system, or can be used when retrofitting an existing system. By placing a bearing insert 20 between the lifting means 15 and the casing 10 and operatively attaching the bearing insert 20 to a location other than the center of the bottom 11 of the casing, the redistribution of load is accomplished. Various embodiments of bearing inserts 20 are shown, for example, in FIGS. 2A, 2B, and 2C.

Note that in both FIGS. 2A and 2B a lower portion of the insert 20 is shown in a cut-away view so as to facilitate viewing a bottom 21.

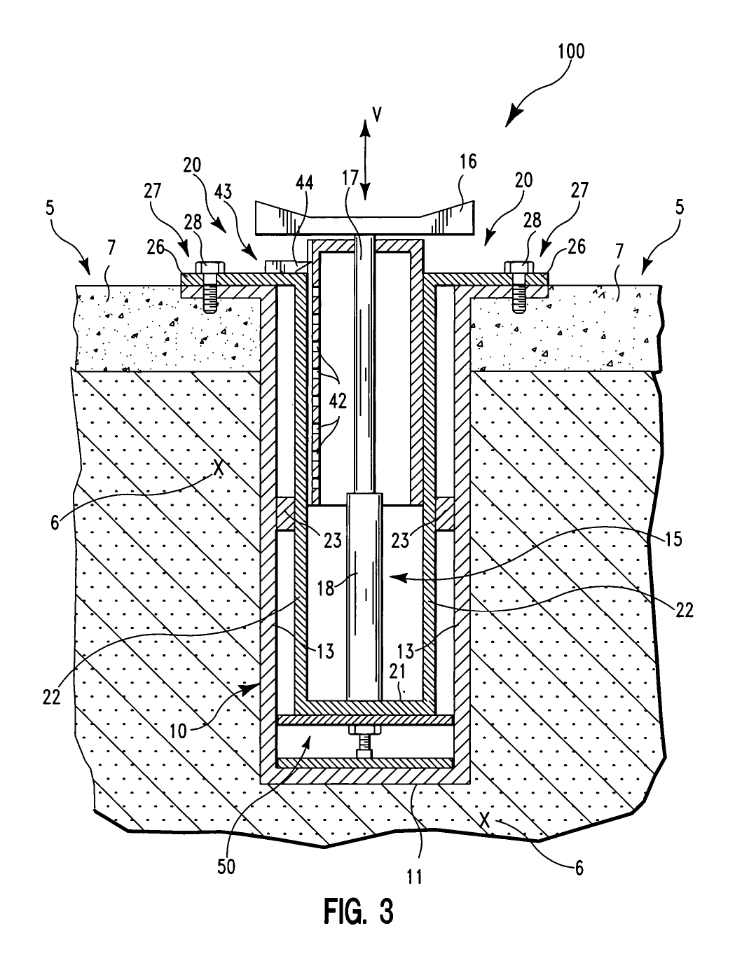

FIG. 2A depicts a first embodiment of an insert 20 that includes a cylindrical sleeve 30 that has a wall 22 and a bottom 21 at the distal end. At the upper, or near, end there is a flange 26 that includes a plurality of holes 27 configured to receive bolts 28 (See FIG. 3) or other attachment devices. The upper flange 26 is configured so as to rest on the upper surface 5 adjacent to the liner 10. There is also an annular rib 23, whose purpose is discussed below.

FIG. 2B depicts a second embodiment of an insert 20 that includes a cylindrical sleeve 30 that has a wall 22 and a bottom 21 at the distal end. At the upper, or near, end there is a flange 26 that includes a plurality of holes 27 configured to receive bolts 28, or other attachment devices. The upper flange 26, in this embodiment however, is configured and sized, so as to rest within the upper end of the liner 10. That is the bolts 28 would be received through the liner wall 13.

FIG. 2C depicts still a third embodiment of an insert 20 that includes a bottom 21 at the distal end. Extending from the bottom 21 to the upper end are a plurality of extensions 25 which extend to a series of attachment flanges 26. In each flange 26 are a plurality of holes 27 configured to receive bolts 28 or other attachment devices. The upper flanges 26 are configured so as to rest on the upper surface 5 adjacent to the liner 10, similar to the embodiment in FIG. 2A.

In one embodiment in which a low volume, high pressure piston and cylinder (whether new or in retrofit application), is placed in an opening 12 in a floor. The opening 12 is typically a vertical shaft extending downward and is lined with a first pre-existing casing 10 that has a casing wall 13. The bottom end 11 of the pre-existing casing 10 is closed. In the present invention, the piston/cylinder assembly (i.e., lifting means 15) bears instead entirely, or in part, on a first bearing element 20. The first bearing element 20 can take many shapes and configurations and is made of a suitable rigid material which can withstand and transfer large load situations.

In another embodiment, in the application of a lift system that is movable (i.e., adjustable with transverse movement) (See e.g., FIG. 1B) the lift mechanism 15 is placed within an existing casing 10 that is suspended from an upper surface 5 and, in essence, hangs over a pit 8. The bearing element 20 is operatively attached to the casing 10.

In one embodiment the bottom of the ram/plunger 15 rests on the first bearing element 20. The first bearing element 20 is attached at the top of the pre-existing casing opening 12. This way, the loads (ram, plunger, superstructure, vehicle, etc.) on the ram and plunger then is transmitted entirely, or in part, to the first bearing element 20. The loads, instead of then being fully transmitted from the first bearing element 20 to the bottom 11 of the pre-existing casing 10, is then partially (or entirely) transmitted to the slab surface 5 surrounding the pre-existing casing opening 12.

Thus, the ram/plunger (i.e., lifting means 15) is operatively attached to the first bearing element 20. The first bearing element 20 is also operatively attached to an element besides the lower end, or bottom 11 of the pre-existing casing 10. The ram/plunger 15 may be also be operatively attached to other elements/parts wherein these other elements/parts provide partial bearing of the loads. Similarly, the first bearing element 20 may additionally be operatively attached to the lower end, or bottom 11 of the pre-existing casing 10.

The first bearing element 20 can be operatively attached to the sides 13 of the pre-existing casing 10 (see e.g., FIG. 2B). For example, the first bearing element 20 can be lag-bolted into the sides 13 of the pre-existing casing 10. The first bearing element 20 can be operatively attached anywhere along the sides of the pre-existing casing 10. The first bearing element 20 may be operatively attached to the top of the pre-existing casing 10, at or near the top of the opening 12 (See e.g., FIG. 3). Alternatively, the first bearing element 20 can be operatively attached to concrete 7, or other rigid material, adjacent to the top opening 12 of the pre-existing casing 10. In this way, little or no concrete 7 removal is required, to install the first bearing element 20 in the retrofit application. The first bearing element 20 may be operatively attached in any one of the above ways, or any combination of the above ways.

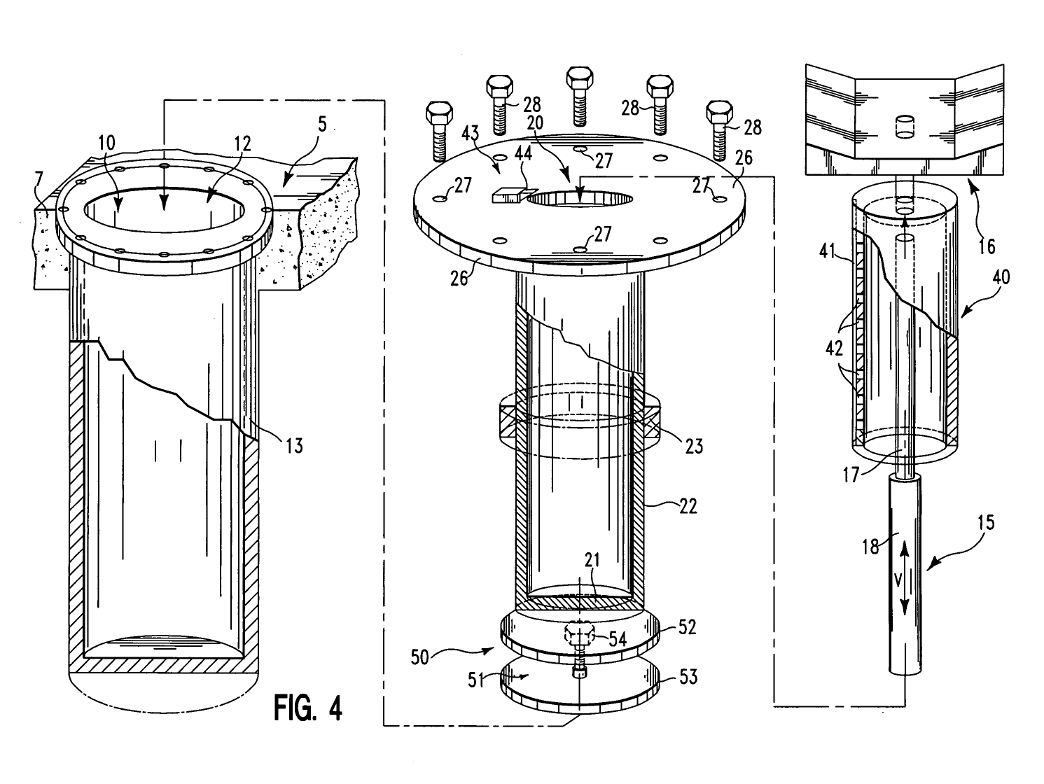

The lifting means 15 (See e.g., FIGS. 3 and 4) may bear on the first bearing element 20 via a myriad of ways. The lifting means 15 may be fixedly attached, removably attached, or just rest on all, or a portion of the first bearing element 20. For example, the bottom of the ram/plunger 15 can rest on the bottom 21 of the first bearing element 20. Alternatively, the ram/plunger 15 can be operatively attached to a side(s) of the first bearing element 20. The middle, or top, of the ram/plunger 15 can be operatively attached to the first bearing element 20. In the present invention, the lifting means 15 may be operatively attached to the first bearing element 20 in any one of the aforementioned ways, or in any combination of the aforementioned ways.

The first bearing element 20 can be of uniform or non-uniform cross-section. The first bearing element 20 can be configured so that it is touching the pre-existing casing's 10 inner surface, or it can be configured so that there is created an interstitial space between the pre-existing casing 10 and the first bearing element 20, upon its installation. This interstitial space, for example, provides an area in which various utility lines (e..g., pneumatic, hydraulic, electric, etc.) can be run.

The first bearing element 20 can have at least one opening on its surface. Indeed, the first bearing element 20 can be one, or a series, of straps 25, for example, wherein the ram/plunger 15 is operatively attached to it, and then the load is distributed through the first bearing element 20 (e.g., via the straps 25) to the operative attachment location(s) of the first bearing element 20 to other locations. See e.g., FIG. 2C.

On the outside of the bearing insert 20 can additionally be some projections that extend laterally. These projections can be ribs 23 (See e.g. FIGS. 2A, 3 and 4). The ribs 23 can be sized so that they bear against, or near, the sides of the casing 10, thereby helping avoid any lateral movement of the bearing insert 20, lifting means 15, superstructure 16, etc. The ribs 23 can be of varying quantity, location, and size.

Conversely, the first bearing element 20 can also be of entirely solid construct, such that it acts additionally as a liner 30. See below for the discussion of the liner 30 feature of the invention. See e.g., FIGS. 2A and 2B.

In the case where the first bearing element 20 is of entirely solid construction, besides acting as a load transference device, the first bearing element 20 may also serve the purpose of being a liner 30. That is the liner 30 is placed between the pre-existing casing 10 and the lifting means 15 (i.e., plunger and ram, etc.). A bottom end of the liner 30 is solid, as are the walls or sides. In the event of a failure of the hydraulic system, the liner 30 will prevent the leakage of any hydraulic fluid to the adjacent pre-existing casing 10 wall and soil substrate 6 beyond.

The liner 30 may be a cylinder, or other suitable shape. Its cross-section may be square, round, or any suitable cross-section. Its length, shape, and configuration is suitable to allow the lifting means 15 to fit within the pre-existing casing 10 opening 12.

A liner 30 is shown in various embodiments in FIGS. 2A, 2B, 3 and 4. An added advantage of having a liner 30 is to catch and trap any fluids should there be a failure of any of the hydraulic systems. Further, the liner 30, besides providing a containment purpose, can also provide an added benefit of keeping out any liquids (e.g., groundwater, previous leaked hydraulic fluids, etc.) from migrating back into the pre-existing casing 10 and/or area where the lifting means 15 resides. This protection will add to the longevity of the various equipment installed within the casing 10 (e.g., lifting means 15, safety lock 43, etc.).

The invention includes a safety device. See e.g., FIGS. 3 and 4. The safety device includes a cylinder 40 which extends longitudinally over the lifting means 15 (e.g., hydraulic ram) and is typically located between the lifting means 15 and superstructure 16. On the cylinder 40 are numerous positions 42 for engagement where a safety lock 43 may releasably engage to. The positions 42 for engagement may be a series of projections 42, or a series of depressions 42 (e.g., slots, grooves, dimples, detents, etc.). The cylinder 40 is of suitable construction (e.g, 1″ thick steel stock) and material so that the engagement of the safety lock 43 into a projection(s) 42 or depression(s) 42 is suitable to hold up the entire weight of the lifting means 15, cylinder 40, superstructure 16, and vehicle, in the event of a failure of the lifting means 15. The cylinder 40 is sized to fit within the pre-existing casing 10 in the ground. Further, if a bearing insert 20 is employed, the cylinder is sized to also fit within the insert 20. In various embodiments, the safety lock 43 may be activated by various suitable means (e.g., pneumatic, hydraulic, electric, mechanical, etc.) In an embodiment the safety lock 43 may be a pawl-type extension 44 for engagement with the projections/depressions 42. Other suitable safety locks 43 may include a latch, dog, pawl, etc. or other suitable locking mechanisms. The series of projections/depressions 42 can be integral (e.g., machined into) with the cylinder 40, or can be on a separate piece of material, and then fixedly attached to the cylinder 40. The cross-section of the cylinder 40 may be any suitable shape, including round, square, etc. An additional advantage of the safety feature of the present invention, is that in order to install the safety device (i.e., safety lock 43, cylinder 40 with depressions/projections 42, etc.) no additional excavation, removal of concrete, and/or boring of potentially contaminated soil is required. As shown in FIG. 4, a groove 41 may be machined along the length of the cylinder 40 along the path of projections 42 so as to offer a path in which the pawl 44 can rid in. The groove 41 also lessens the possibility of any axial rotation, or “play” in the cylinder 40 and lifting means 15. In this manner, the safety lock 43 also acts as a stabilizer, of sorts.

The cylinder 40 in depicted in FIGS. 3 and 4 have a series of depressions 42 (e.g., holes) that are integral with the cylinder 40. In this embodiment the cylinder 40 is sized to fit within the pre-existing casing 10 and the insert 20 and is round in cross-section. The safety lock 43 in this embodiment may be located at, or near, the top opening 12 of the pre-existing casing 10. Although in the embodiment shown in FIGS. 3 and 4 an insert 20/support liner 30 is used, the installation of the cylinder 40, safety lock 43, and associated appurtenances may be installed without an insert 20. This allows for the installation of a safety system to a vehicle lift system (either new or existing) without any additional excavation or concrete removals.

Another aspect is a depth adjustment mechanism 50 (see e.g., FIGS. 2A, 3, and 4). The depth adjustment mechanism 50 can act as a footer, thereby providing additional stability (i.e., lateral and vertical) and load bearing surface area. The depth adjustment mechanism 50 may be located between the lifting means 15 and the bottom 11 of the pre-existing casing. Alternatively, there may be additional elements/pieces/parts located between the bottom of the lifting means 15 and the depth adjustment mechanism 50. Similarly, there may be additional elements/pieces/parts located between the bottom of the depth adjustment mechanism 50 and the bottom 11 of the pre-existing casing. Ultimately, the lifting means 15 and the depth adjustment mechanism 50 are operatively attached to each other.

The function of the depth adjustment mechanism 50 is multiple. First, it serves as an element that may take part, or all, of the bearing load of the construct that is above it (i.e., lifting means 15, vehicle, superstructure 16, etc.) and distributes it below to the bottom of the pre-existing casing 10. Recall from above that the first bearing element 20 (if used) takes part, or all, of this same bearing load. Further, the addition of an depth adjustment mechanism 50 below the lifting means 15 provides several advantages including, amongst others, faster system installation time; eliminating the need for measuring the depth of casing 10 in advance of the installation date; an increased system service life; and, reduction of production costs. The increased system service life is obtained, in part, by the prevention, or minimizing, of “slopping”, which is the lateral and/or vertical movement, over time, of the system(s) within the pre-existing casing 10. For example, the exact depth of the pre-existing casing 10 does not need to be known in order to pre-select a certain length of depth adjustment mechanism 50, because the depth adjustment mechanism 50 can be fully adjusted in the “field”, during installation. That is an installer can readily extend, or shorten, multiple times the length of the depth adjustment mechanism 50 in order to get the depth adjustment mechanism 50 to a requisite length to adequately act as a footer. The depth adjustment mechanism 50 is therefore user adjustable and user selectable in its length. Upon completion of proper installation, the depth of the total of the lifting means 15 (e.g., hydraulic piston and ram) plus the depth of any item(s) (including the depth adjustment mechanism 50) below the lifting means 15 should be approximately equal to the depth of the pre-existing casing 10. Thus, in typical installations, an installer may attach the lifting means 15 to the depth adjustment mechanism 50. This attachment may be done via welding, bolting, etc. or any other suitable attachment means. Next, the combination of the lifting means 15 and the depth adjustment mechanism 50 are placed within the pre-existing casing 10 as a unit. While in the pre-existing casing 10, the depth adjustment mechanism 50 may be adjusted (upwards or downwards) once, or a plurality of times, so that the lifting means 15 is ultimately located at the correct, desired elevation. This is typically done by rotating appropriately the lifting means 15 with the depth adjustment mechanism 50 operatively attached thereto. An alternative installation method is for the depth adjustment mechanism 50 to be first placed in the pre-existing casing 10, followed then by the lifting means 15.

In embodiments that do not have the first bearing element 20 portion of the invention, the depth adjustment mechanism 50 may take the entire bearing load from above. That is the depth adjustment mechanism 50 may be used with, or without, the bearing element 20.

The depth adjustment mechanism 50 can serve an additional function of assisting in preventing any lateral movement of the lifting means 15, support liner 30, superstructure 16, etc. The depth adjustment mechanism 50 may include a bearing plate 52, on which the lifting means 15 rests and a footer plate 53. Extending upwards from the footer plate 53 is an adjustment element 51 (e.g., threaded rod). Conversely, extending downward form the underside of the bearing plate 52 is an element 54 that communicates with the adjustment element 51. For example, the element 54 may be female threads that interact with the threaded rod 51. Further, the outer portion of the element 54 may be designed so as to receive a tool (e.g., wrench) so that height adjustment (denoted by directional arrows “V”) of the mechanism 50 is readily obtained. As the embodiments in FIGS. 2A, 3 and 4 indicate, the depth adjustment mechanism 50 may reduce any lateral movement in the various parts by having either the bearing plate 52, footer plate 53, or both, be sized to fully fill the width of the bottom of the pre-existing casing 10.

In one embodiment, the depth adjustment mechanism 50 is an adjustable screw-jack. For example, the adjustable screw-jack may be a model such as those manufactured by Acme Screw Thread. This adjustable depth mechanism 50 can be adjusted prior to its installation so that when the lifting means 15 is placed in the pre-existing casing opening 12 and on the depth adjustment mechanism 50 or is placed on the depth adjustment mechanism 50 and the first bearing element 20, it results in a precise fit.

Note that while the depth adjustment mechanism 50 is shown installed in the embodiments in FIGS. 2A, 3 and 4, the depth adjustment mechanism 50 can be installed under a lifting means 15 with, or without, the bearing insert 20; with, or without, the liner 30; and, with, or without the safety aspects of the present invention. For example, a depth adjustment mechanism 50 may be installed underneath the bearing insert 20 embodiments shown in FIGS. 2B and 2C.

Further, the depth adjustment mechanism 50 need not have a separate bearing plate 52. The adjustment element 51 could, for example, be attached directly to the underside of the bottom 21. In this type of embodiment, the bottom 21 would act as the bearing plate 52. For example, the footer plate 53, adjustment element 51, and element 54 could be field welded, as a unit to the underside of the bottom 21.

As disclosed in the embodiments in FIGS. 3 and 4, an additional feature is the placement of a sump 110 at, or near, the bottom of the pre-existing casing 10. The sump 110 may be attached to the depth adjustment mechanism 50, or may be situated separately therefrom. For example, a pneumatic sump 110 may be used. The sump 110 may be configured so that it is activated when the safety is released, or upon the detection of moisture, or upon another suitable activity.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

1. A bearing device for retrofitting a vehicle lift system, wherein said vehicle lift system includes a casing with an opening at proximal end of an upper portion and a bottom at a distal end, said device comprising:
a first end adapted to receive a vehicle lifting device; and
a second end adapted to operatively attach to said upper portion.

2. The bearing device of claim 1, further wherein said device is a liner.

3. A device for retrofitting a vehicle lift system, wherein said vehicle lift system includes a casing, said casing having an upper portion and a bottom portion, said casing inserted within a floor having an opening therein and a bottom at the distal end of the casing, said device comprising:
a first end adapted to receive a vehicle lifting device; and
a second end adapted to operatively attach at least one of said floor and said upper portion.

4. The device of claim 3, further wherein said device is waterproof.

5. A load transference device for use with vehicle lift systems, said systems including a casing and a vehicle lift mechanism configured to fit within said casing, said device comprising:
a load receiving element, said element configured to receive substantially all of a load from said vehicle lift mechanism;
at least one load transferring element, structurally attached to said load receiving element, configured to receive all of said load;
at least one attachment flange, structurally attached to said at least one load transferring element, configured to attach to at least one of an upper portion of said casing and a slab adjacent to said casing, configured to receive all of said load; and
further wherein, said device is configured to substantially fit within said casing.

6. A device for use with a vehicle lift system, said system including a casing for receiving a pneumatic vehicle lifting device, said lifting device including a ram and a cylinder operatively attached to a superstructure, said device comprising:
a cylindrical element, configured to be attached between said lifting device and said superstructure, said element including on an outside surface a plurality of engagement locations, said plurality of locations configured to be operatively engagable with a safety mechanism.

7. The device of claim 6, further comprising the safety mechanism.

8. The device of claim 6, wherein said device is configured to fit within said casing.

9. A method of retrofit of a pre-existing vehicle lift system, the method comprising the steps of:
removing a plunger of the pre-existing vehicle lift system;
installing a self contained or sealed hydraulic cylinder and associated hydraulic lines within a casing of the pre-existing vehicle lift system; and
installing a plunger associated with said cylinder using said casing or a sleeve therein as a guide for said plunger.

10. The method of claim 9, further comprising removing a superstructure of the pre-existing vehicle lift system.

11. The method of claim 9, further comprising excavating a portion of a solid structure surrounding a top of said casing.

12. The method of claim 9, further comprising removing at least a portion of a hydraulic fluid of the pre-existing vehicle lift system.

13. The method of claim 9 further comprising removing at least one guide means associated with said plunger of the pre-existing vehicle lift system.

14. The method of claim 9, wherein said hydraulic cylinder has properties of a varying combination of pressure and volume characteristics.

15. The method of claim 9 wherein said hydraulic cylinder is a high pressure low volume cylinder.

16. The method of claim 9 further comprising installing a power unit for said hydraulic cylinder.

17. The method of claim 9 further comprising installing a pneumatic actuator for said hydraulic cylinder.
